(19) United States
(12) Patent Application Publication
(10) Pub. No.: US 2015/0012537 A1
(43) Pub. Date: Jan. 8, 2015

(54) ELECTRONIC DEVICE FOR INTEGRATING AND SEARCHING CONTENTS AND METHOD THEREOF

(71) Applicant: Samsung Electronics Co., Ltd., Gyeonggi-do (KR)

(72) Inventors: Yeon-A Yi, Gyeonggi-do (KR); Chul-Hwan Lee, Seoul (KR)

(21) Appl. No.: 14/323,995

(22) Filed: Jul. 3, 2014

(30) Foreign Application Priority Data
Jul. 3, 2013 (KR) 10-2013-0077863

(51) Int. Cl. G06F 17/30

(52) U.S. Cl. CPC G06F 17/30598
USPC 707/737

(57) ABSTRACT

An electronic device for integrating and searching contents and a method thereof. The method includes extracting tag information of at least one contents executed in at least one application, classifying at least the one executed contents based on the extracted tag information according to types of the contents, and displaying the classified contents according to a set order.

### PRIORITY

The present application is related to and claims the benefit under 35 U.S.C. §119(a) of a Korean patent application filed in the Korean Intellectual Property Office on Jul. 3, 2013 and assigned Serial No. 10-2013-0077863, the entire disclosure of which is hereby incorporated by reference.

### TECHNICAL FIELD

The present disclosure relates to an electronic device for integrating and searching contents and a method thereof.

### BACKGROUND

There is an inconvenience in that a user of an electronic device must enter into an application and manually input a title of contents to be executed to the electronic device to execute the application installed in the electronic device.

For example, in order to reproduce a sound source, the user must enter into an application which may reproduce the sound source and input a title of the sound source or a name of a singer of the sound source. Also, in order to reproduce a movie, the user must enter into an application which may reproduce the movie and input a title of the movie or a name of an actor or actress. Also, when the user does not remember an accurate title of contents to be reproduced, an inconvenience of the user is increased.

Therefore, it is urgent to develop an apparatus and method for improving an inconvenience in which a user must enter into an application and input an accurate title of contents to execute the specific contents by providing a plurality of contents executed in the electronic device in an integrated manner according to a set order.

### SUMMARY

To address the above-discussed deficiencies, it is a primary object to provide an apparatus and method for easily searching and reproducing contents and improving convenience of a user by providing a plurality of contents which are executed in each of a plurality of applications according to an order set in one application.

Another aspect of the present disclosure is to provide an apparatus and method for solving an inconvenience of a user because the user selects contents to be reproduced among provided contents without the necessity of inputting an accurate title of the contents to be reproduced.

In accordance with one aspect of the present disclosure, an operation method of an electronic device is provided. The operation method includes extracting tag information of at least one contents executed in at least one application, classifying at least the one executed contents based on the extracted tag information according to types of the contents, and displaying the classified contents according to a set order.

In accordance with another aspect of the present disclosure, an electronic device is provided. The electronic device a processor module for extracting tag information of at least one contents executed in at least one application and classifying at least the one executed contents based on the extracted tag information according to types of the contents and a touch screen for displaying the classified contents according to a set order.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A to 1D illustrate an electronic device for integrating and searching contents according to one embodiment of the present disclosure;

FIG. 2 illustrates a process of extracting tag information from each of contents in an integrated search application according to one embodiment of the present disclosure;

FIGS. 3A to 3D illustrate a process of searching and executing displayed contents in an integrated search application according to one embodiment of the present disclosure;

FIGS. 4A to 4D illustrate a process of searching and executing contents displayed on an integrated search application according to another embodiment of the present disclosure;

FIGS. 5A to 5C illustrate a process of displaying executed contents according to display priority in an integrated search application according to one embodiment of the present disclosure;

FIGS. 6A to 6D illustrate a process of searching contents to which titles are not added in an electronic device according to one embodiment of the present disclosure;

FIGS. 7A to 7D illustrate a process of providing information about selected contents in an electronic device for providing an integrated search application according to one embodiment of the present disclosure;

FIG. 8 is a flowchart illustrating an operation process of an electronic device according to one embodiment of the present disclosure;

FIG. 9A is a flowchart illustrating a process of integrating and searching executed contents in an electronic device according to one embodiment of the present disclosure;

FIG. 9B is a block diagram illustrating configuration of an electronic device for integrating and searching executed contents according to one embodiment of the present disclosure; and

FIG. 10 is a block diagram illustrating configuration of an electronic device according to one embodiment of the present disclosure.

### DETAILED DESCRIPTION

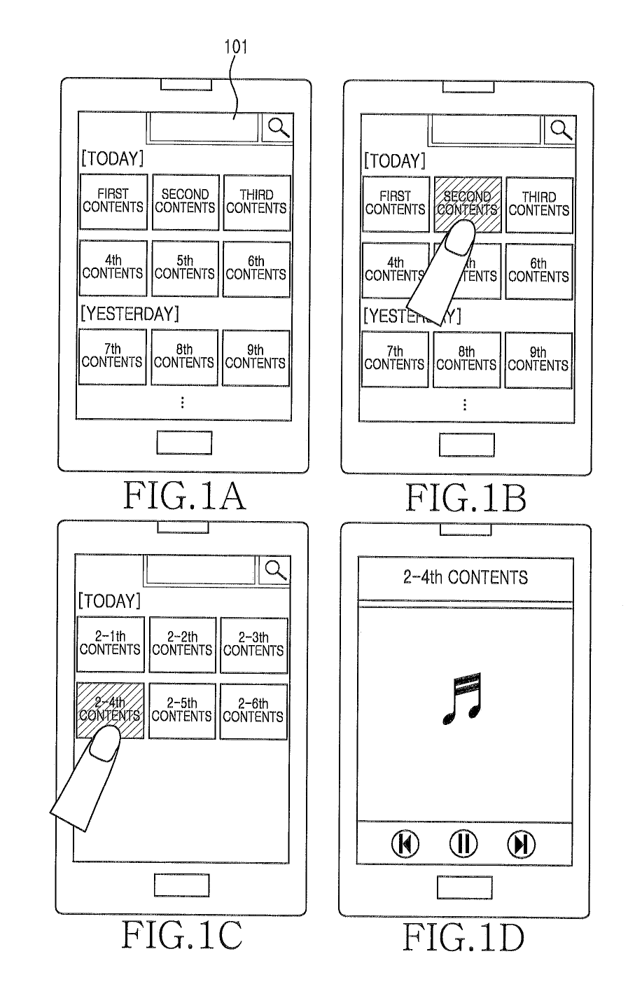

FIGS. 1A through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Exemplary embodiments of the present disclosure will be described herein below with reference to the accompanying drawings. In the following description, well-known functions or constructions are not described in detail since they would obscure the disclosure in unnecessary detail.

FIGS. 1A to 1D illustrate an electronic device for integrating and searching contents according to one embodiment of the present disclosure.

Hereinafter, a description will be given when at least one or more applications are installed in the electronic device and the electronic device executes at least one or more applications among the installed applications. A description will be given when the electronic device receives input to execute an integrated search application which may integrate and search at least one contents executed in at least one application. Also, in one embodiment of the present disclosure, an application and contents may include all of singular and plural applications and singular and plural contents, respectively.

First of all, receiving input to execute the integrated search application, the electronic device may extract tag information of contents executed in the application. In more detail, receiving the input to execute the integrated search application, the electronic device may extract tag information of contents executed in the application to classify contents executed therein according to types of the contents. Herein, the tag information may be at least one of the same face among faces included in the contents executed in the application, types of the contents, a time when the contents are generated, and a place where the contents are generated.

Thereafter, the electronic device may classify the executed contents according to types of contents based on the extracted tag information. In more detail, the electronic device may classify contents of the same type among the executed contents while being classified according to a time when the contents are generated, a place where the contents are generated, and the same face among faces included in the contents. For example, a description will be given when a sound source playback application, a video playback application, and an image viewer application are executed.

As described above, the electronic device may divide the contents into sound sources, videos, images, etc. roughly based on the tag information extracted from each of the executed contents. Thereafter, in order to classify the divided contents again in detail, the electronic device may classify the divided contents while being classified according to a time when each of the contents is generated, a place where each of the contents is generated, and the same face among faces included in the contents. That is, the electronic device may verify a sound source executed in the sound source playback application and a time when the sound source is reproduced. Also, the electronic device may verify a video executed in the video playback application and a time when the video is reproduced. Also, the electronic device may classify an image generated in the image viewer application while being classified according to a time when the image is generated, a place where the image is generated, and the same face among faces included in the image.

Thereafter, as shown in FIG. 1A, the electronic device may display the classified contents on the touch screen according to a set order. In more detail, the electronic device may classify contents primarily in the order of a time when the contents are executed, verify display priority of the classified contents secondarily, and display the contents. Herein, the executed time unit may include at least one of a day unit, a week unit, a month unit, and a year unit.

For example, as shown in FIG. 1A, a description will be given when contents which are executed “today” are 6 contents and contents which were executed “yesterday” are 3 contents in the electronic device. Also, a description will be given when display priority of contents classified in the electronic device is set in the order of first contents associated with a first application, second contents associated with a second application, and third contents associated with a third application.

As described above, the electronic device may classify the 6 contents which are executed “today” and the 3 contents which were executed “yesterday” roughly in the order of the time when the contents are executed among the total 9 contents which are first executed. Thereafter, the electronic device may verify display priority of each of the classified contents before distinctively displaying the 6 contents which are executed “today” and the 3 contents which were executed “yesterday” while being classified according to the executed date. That is, the electronic device may verify the display priority of each of the contents and display the 6 contents which are executed “today” in the order of first to 6^{th} contents on the touch screen. Also, the electronic device may display the 3 contents which were executed “yesterday” in the order of 7^{th} to 9^{th} contents on the touch screen. Herein, the electronic device extract sentence and important information, which is frequently used while being classified according to each of the contents, as a tag and display the extracted tag together with each of the contents. For example, the electronic device may display information about a word which is repeated many times in an email received today or a sender who sends a set number or more of emails, etc. together with a thumbnail.

Thereafter, as shown in FIG. 1B, the electronic device may receive user input for selecting any one of the contents displayed on the touch screen. In more detail, the electronic device may receive user input for selecting any one contents displayed according to a unit of the time when each of the contents is executed and the display priority. For example, as shown in FIG. 1B, the electronic device may receive selection of the second contents displayed second in a time unit called “today”.

As shown in FIG. 1C, when there are one or more contents of the same type as the selected contents, the electronic device may display all contents of the same type as the selected contents on the touch screen. That is, because the electronic device may integrate and distinguish contents of the same type when distinguishing contents based on extracted tag information while being classified according to types of contents, contents of one type may include a plurality of contents. For example, the electronic device executes a music application and reproduces 6 sound sources “today”. When second contents which are sound source contents executed “today” are selected, the electronic device may display 2-1^{th} to 2-6^{th} contents which are sound source contents of the same type on the touch screen.

As shown in FIG. 1D, the electronic device may execute an application which may reproduce any one contents selected among the contents displayed on the touch screen. In more detail, when contents displayed on the touch screen are selected, the electronic device may automatically execute an application which may reproduce the selected contents and reproduce the selected contents. For example, as shown in FIGS. 1C and 1D, when 2-4^{th} contents which are sound source contents are selected, the electronic device may execute a sound source playback application and reproduce a sound source called the 2-4^{th} contents.

Also, the electronic device according to one embodiment of the present disclosure may have a search window 101 in a set region and also search stored contents manually. For example, when a title, etc. associated with specific contents is input to the search window 101, the electronic device may search the input contents and display the searched contents on the touch screen.

Also, according to one embodiment of the present disclosure may consider contents downloaded through a web browser as well as executed contents when executing an integrated application.

In order to reproduce contents executed through applications again in a conventional electronic device, a user of the conventional electronic device may need to select each of the applications, search desired contents, and execute the searched application separately. Accordingly, even if contents are frequently executed, there is an inconvenience in that the user may need to select an application which may execute contents to be reproduced separately and search and reproduce contents to be reproduced in the selected application again.

However, the electronic device according to one embodiment of the present disclosure may improve convenience of the user by searching a plurality of contents executed in various applications once through an integrated search application. Also, the electronic device may easily execute contents recently searched by displaying executed contents in the order of time. Also, the electronic device may reduce interaction of the user by displaying contents which are frequently executed at the forefront because the user may set priority for displaying contents. Also, there is an advantage in that the electronic device may automatically execute an application which may reproduce selected contents when any one of contents displayed through the integrated search application is selected. Also, there is an advantage in that the electronic device may fulfill various needs of the user by having the search window 101 which may manually search contents in the integrated search application.

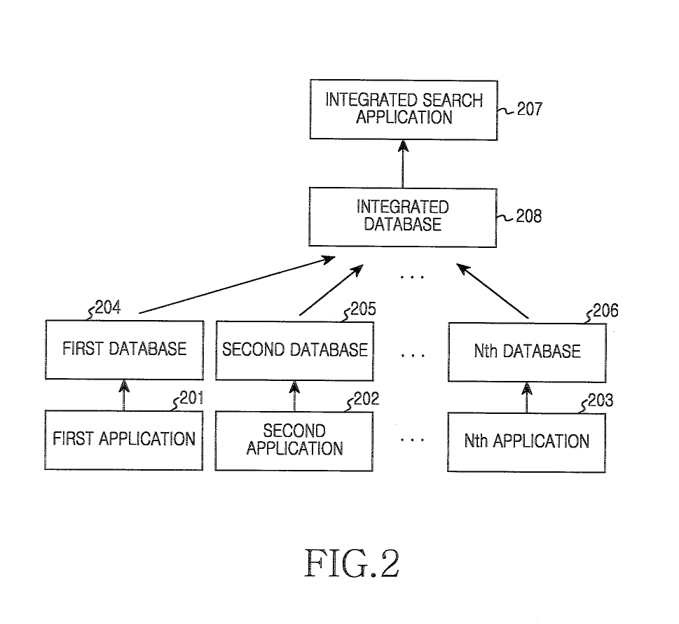

FIG. 2 illustrates a process of extracting tag information from each of contents in an integrated search application according to one embodiment of the present disclosure.

Hereinafter, a description will be given for an example of when N applications 201 to 203 are installed in an electronic device and an integrated search application 207 which may search contents executed in the N applications 201 to 203 installed in the electronic device in an integrated manner is installed in the electronic device.

As shown in FIG. 2, each of the N applications 201 to 203 installed in the electronic device is connected to a corresponding one of N databases 204 to 206. In more detail, the first application 201 is connected with the first database 204. The second application 202 is connected with the second database 205. The N^{th} application is connected with the N^{th} database 206.

Herein, the corresponding one of the first to N^{th} databases 204 to 206, which is connected to each of the first to N^{th} applications 201 to 203 installed in the electronic device, may extract tag information from contents executed through each of the first to N^{th} applications 201 to 203. In more detail, the corresponding one of the first to N^{th} databases 204 to 206 may extract tag information of contents reproduced in each of the first to N^{th} applications 201 to 203, such that an integrated database 208 may verify the tag information of the contents reproduced in each of the first to N^{th} applications 201 to 203.

For example, a description will be given when the first application 201 is an application which may reproduce sound sources, the second application 202 is an application which may photograph and store images, and the N^{th} application 203 is an application which may execute videos. Also, a description will be given when the first application 201 reproduces 3 sound sources, the second application 202 generates and stores 2 images, and the N^{th} application 203 executes 1 video.

As described above, the first database 204 connected with the first application 201 may extract the 3 sound sources reproduced in the first application 201 and tag information associated with a time when each of the 3 sound sources is reproduced. Also, the second database 205 connected with the second application 202 may extract the 2 images photographed through the second application 202 and tag information about a time when each of the 2 images is generated, a place where each of the 2 images is generated, faces included in each of the 2 images, etc. Also, the N^{th} database 206 connected with the N^{th} application 203 may extract the video executed in the N^{th} application 203 and tag information such as a time when the video is reproduced, etc.

Thereafter, the integrated database 208 connected with the integrated search application 207 and the first to N^{th} application 201 to 203 may receive the tag information extracted from each of the first to N^{th} databases 204 to 206. For example, the integrated database 208 may receive the tag information extracted from the first to N^{th} databases 204 to 206 to transmit the tag information about the contents executed in each of the first to N^{th} application 201 to 203.

Accordingly, when a command for starting an integrated search is input, the integrated search application 207 may integrate and search the contents executed in the first to N^{th} application 201 to 203 based on the tag information transmitted from the integrated database 208.

In one embodiment of the present disclosure, the description was given when the electronic device may have the corresponding one of the first to N^{th} databases 204 to 206 per each of the first to N^{th} application 201 to 203. However, the electronic device may have only the integrated database 208 without having the corresponding one of the first to N^{th} databases 204 to 206 per each of the first to N^{th} application 201 to 203. That is, the integrated database 208 may also play a role in the first to N^{th} databases 204 to 206.

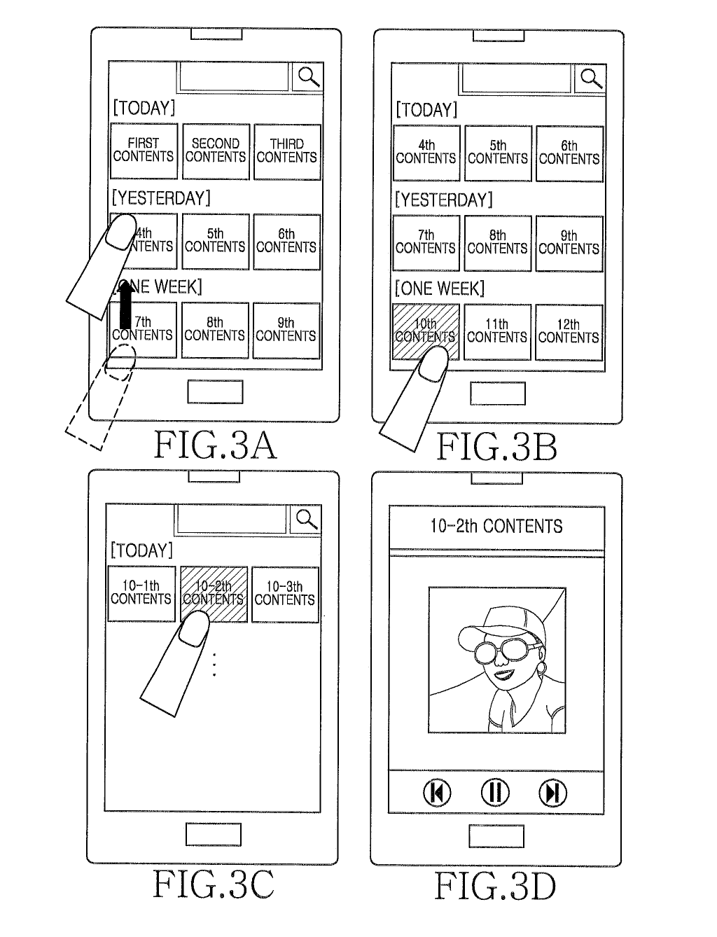

FIGS. 3A to 3D illustrate a process of searching and executing displayed contents in an integrated search application according to one embodiment of the present disclosure.

Hereinafter, a description will be given when a plurality of applications are installed in an electronic device and the electronic device executes at least one or more applications among the plurality of installed applications. Also, a description will be given when the electronic device receives input to execute an integrated search application which may integrate and search contents executed in each of the plurality of applications.

As shown in FIG. 3A, the electronic device may classify contents primarily in the order of a time when the contents are executed, verify display priority of each of the classified contents secondarily, and display the contents. Herein, the executed time unit may include at least one of a day unit, a week unit, a month unit, and a year unit.

For example, as shown in FIG. 3A, a description will be given when contents which are executed “today” are 3 contents and contents which were executed “yesterday” are 3 contents in the electronic device. Also, a description will be given when display priority of contents classified in the electronic device is set in the order of first contents associated with a first application, second contents associated with a second application, and third contents associated with a third application.

As described above, the electronic device may classify the 3 contents which are executed “today” and the 3 contents which were executed “yesterday” roughly in the order of the time when the contents are executed among the total 6 contents which are first executed. Thereafter, the electronic device may verify display priority of each of the classified contents before distinctively displaying the 3 contents which are executed “today” and the 3 contents which were executed “yesterday” while being classified according to the executed date. That is, the electronic device may verify the display priority of each of the contents and display the 3 contents which are executed “today” in the order of first to third contents on the touch screen. Also, the electronic device may display the 3 contents which were executed “yesterday” in the order of 4^{th} to 6^{th} contents on the touch screen.

As shown in FIG. 3A, receiving touch input of a specific region of the specific search application and sensing an operation for scrolling up the touch input, the electronic device may display each of contents classified on the basis of a time unit such as “one month” and “one year”.

Thereafter, as shown in FIG. 3B, the electronic device may receive user input for selecting any one of the contents displayed on the touch screen. For example, as shown in FIG. 3B, the electronic device may receive user input for selecting 10^{th} contents displayed first among contents which are distinctively displayed on the basis of a time unit such as “one month”.

As shown in FIG. 3C, when there are a plurality of contents of the same type as the selected contents, the electronic device may display all contents of the same type as the selected contents. For example, a description will be given when the electronic device executes a camera application and generates 3 images within one month from a current time point. As described above, when the 10^{th} contents which are image contents generated within one month from the current time point are selected, the electronic device may display 10-1^{th} to 10-3^{th} contents which are image contents of the same type on the touch screen.

As shown in FIG. 3D, the electronic device may execute an application which may reproduce any one contents selected among the contents displayed on the touch screen. For example, as shown in FIGS. 3C and 3D, when 10-2^{th} contents which are image contents are selected, the electronic device may automatically execute a camera application or a gallery application which may store images and display an image including a person's face called the 10-2^{th} contents.

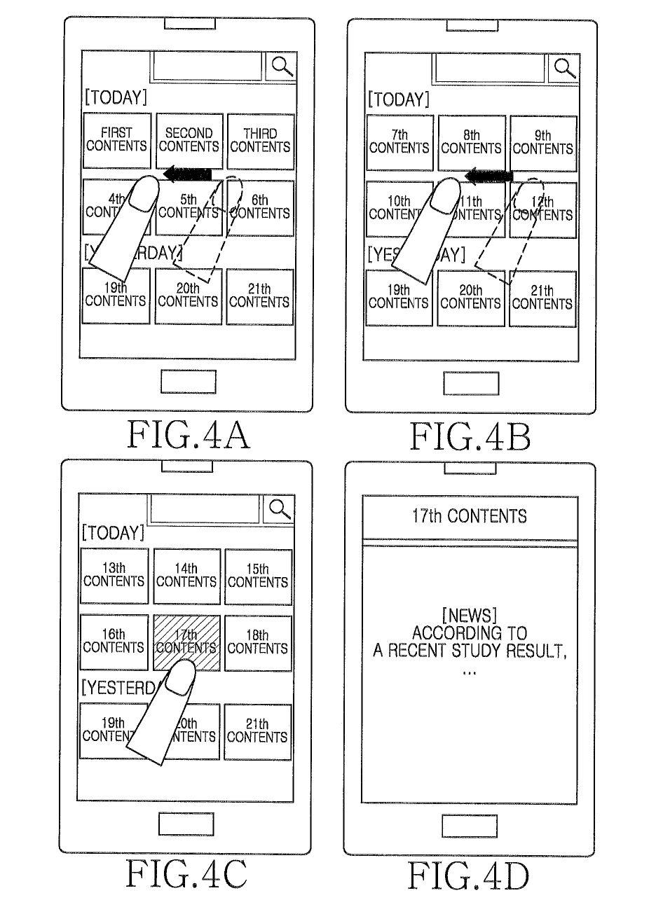

FIGS. 4A to 4D illustrate a process of searching and executing contents displayed on an integrated search application according to another embodiment of the present disclosure.

Hereinafter, it is assumed that a plurality of applications are installed in an electronic device and the electronic device executes at least one or more applications among the plurality of installed applications. Also, a description will be given when the electronic device receives input to execute an integrated search application which may integrate and search contents executed in each of the plurality of applications.

As shown in FIG. 4A, the electronic device may classify contents primarily in the order of a time when the contents are executed, verify display priority of each of the classified contents secondarily, and display the contents.

As shown in FIG. 4A, receiving touch input of a specific region of an integrated search application and sensing an operation for scrolling left or right the touch input, the electronic device may distinguish and display contents classified in a “today” time unit from contents classified in a “yesterday” time unit. That is, when the integrated search application is executed, the electronic device according to one embodiment of the present disclosure may sense an operation which is scrolled left and right and display contents distinctively in a time unit on the touch screen.

For example, as shown in FIGS. 4A to 4C, receiving touch input of a specific region of the “today” time unit and sensing an operation for scrolling left the touch input, the electronic device may move only contents (first to 6^{th} contents) distinctively displayed in the “today” time unit to the left and display contents (7^{th} to 18^{th} contents) which are not displayed on the touch screen such that contents (9^{th} to 21^{th} contents) distinctively displayed in the “yesterday” time unit are not moved.

As shown in FIG. 4C, the electronic device may receive user input for selecting any one of contents displayed on the touch screen.

As shown in FIG. 4D, the electronic device may execute an application which may reproduce any one contents selected among the contents displayed on the touch screen. For example, as shown in FIGS. 4C and 4D, when 17^{th} contents which are text contents are selected, the electronic device may execute a web browser to connect to an address where text is located and display the text which is a news article called the 17^{th} contents.

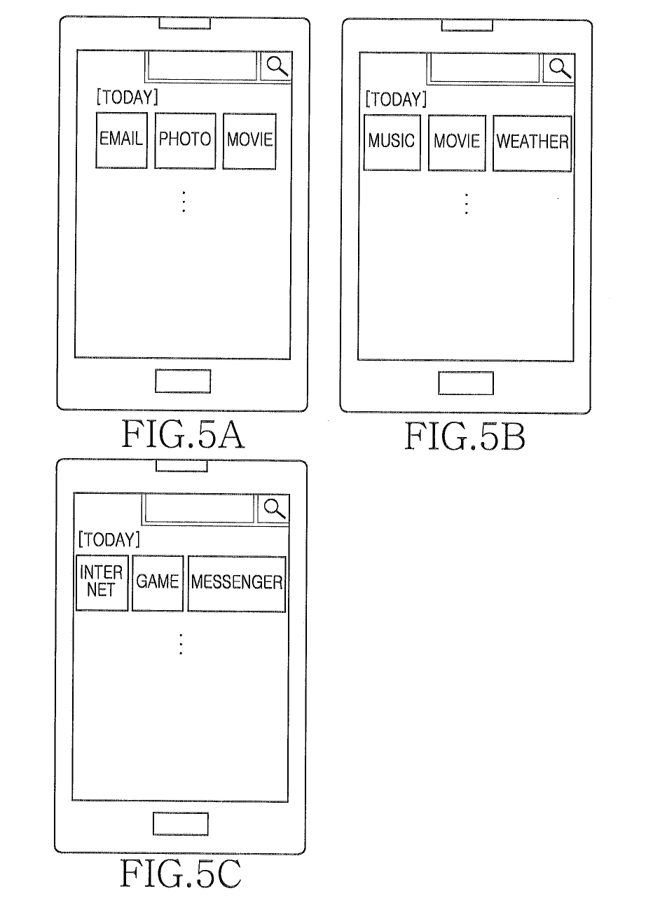

FIGS. 5A to 5C illustrate a process of displaying executed contents according to display priority in an integrated search application according to one embodiment of the present disclosure.

An electronic device may classify contents primarily in the order of a time when the contents are executed, verify display priority of each of the classified contents secondarily, and display the contents.

For example, as shown in FIG. 5A, if display priority is set in the order of contents associated with an email, an image, and a video when a plurality of contents executed in the electronic device are displayed in an integrated search application, the electronic device may display the plurality of contents in the order of the contents associated with the email, the image, and the video on the touch screen.

Also, as shown in FIG. 5B, if display priority is set in the order of image contents associated with a sound source, a video, and a weather when a plurality of contents executed in the electronic device are displayed in the integrated search application, the electronic device may display the plurality of contents in the order of the image contents associated with the sound source, the video, and the weather on the touch screen.

Also, as shown in FIG. 5C, if display priority is set in the order of contents associated with the Internet, a game, and a messenger when a plurality of contents executed in the electronic device are displayed in an integrated search application, the electronic device may display the plurality of contents in the order of the contents associated with the Internet, the game, and the messenger on the touch screen.

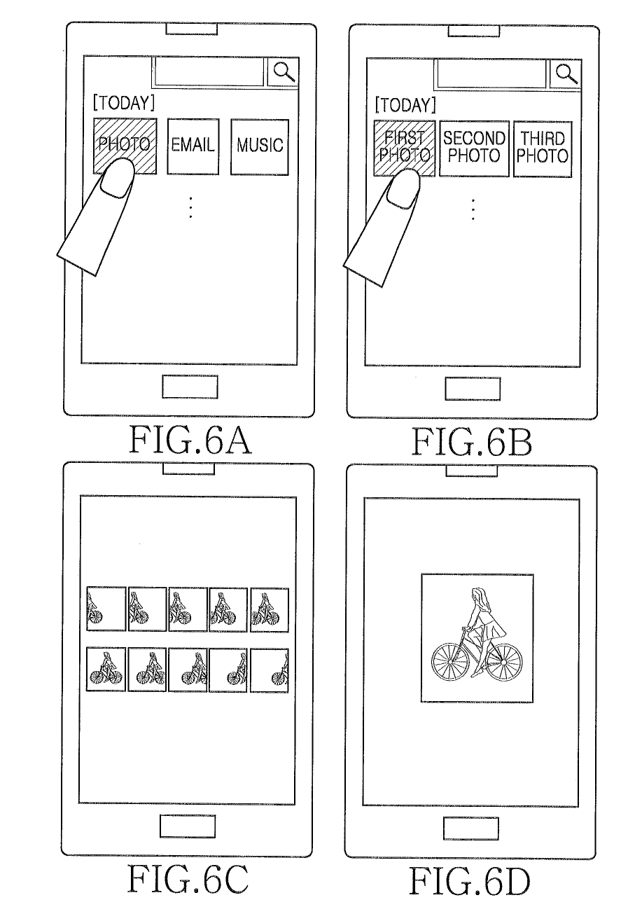

FIGS. 6A to 6D illustrate a process of searching contents to which titles are not added in an electronic device according to one embodiment of the present disclosure.

As shown in FIG. 6A, the electronic device may classify contents primarily in the order of a time when the contents are executed, verify display priority of each of the classified contents secondarily, and display the contents.

Thereafter, as shown in FIGS. 6A and 6B, receiving user input for selecting contents called a photo which stores a plurality of images photographed “today”, the electronic device may display the plurality of images photographed “today” on the touch screen.

As shown in FIGS. 6B and 6C, when one of the displayed contents is selected, the electronic device may display one or more contents included in the selected contents on the touch screen. For example, as shown in FIGS. 6B and 6C, if a first photo is selected among a plurality of photos, the electronic device may display a plurality of photos included in the first photo. That is, the first photo is a photo which is successively photographed within a set time in the electronic device. The plurality of photos are included and displayed in the first photo which is one contents.

As shown in FIG. 6C, the electronic device may receive user input for selecting any one of the plurality of contents displayed on the touch screen. For example, as shown in FIG. 6C, the electronic device may receive user input for select a 6^{th} photo among 10 photos displayed on the touch screen. Thereafter, as shown in FIG. 6D, the electronic device may display the selected contents on the touch screen.

When titles of contents executed in a conventional electronic device, such as image contents, are not accurately added, there is an inconvenience in that a user of the conventional electronic device may need to execute an application which stores contents to be separately searched and search contents separately and manually.

However, the user of the electronic device according to one embodiment of the present disclosure executes the integrated search application. If the user remembers only a time when contents to be searched are reproduced or generated, there is an advantage in that he or she search contents easily.

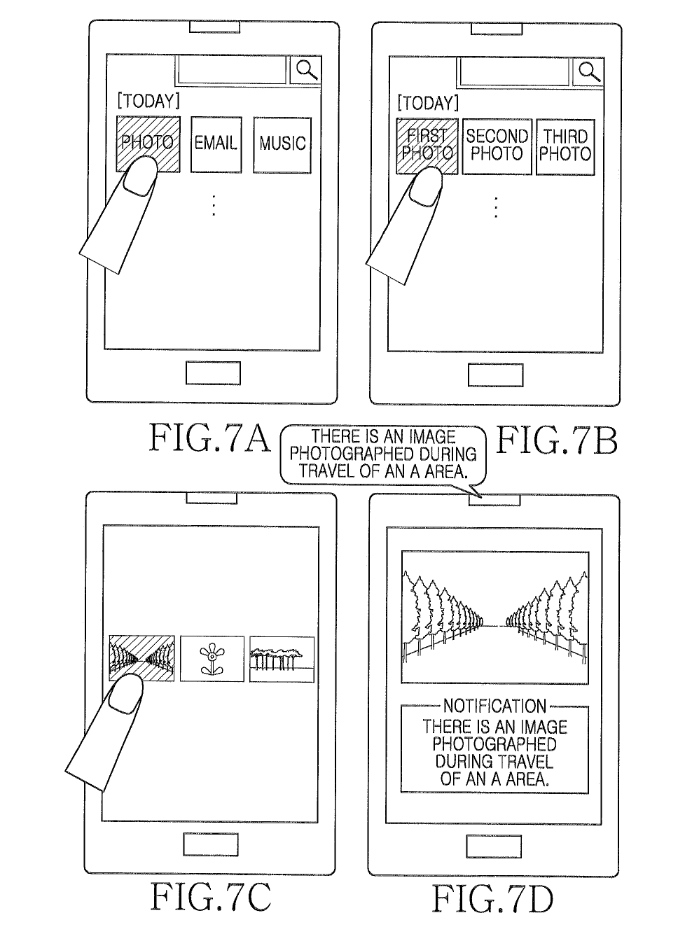

FIGS. 7A to 7D illustrate a process of providing information about selected contents in an electronic device for providing an integrated search application according to one embodiment of the present disclosure.

As shown in FIGS. 7A and 7B, the electronic device may classify contents primarily in the order of a time when the contents are executed, verify display priority of each of the classified contents secondarily, and display the contents.

Thereafter, receiving user input for selecting contents called a photo which stores a plurality of images photographed “today”, the electronic device may display the plurality of images photographed “today” on the touch screen.

As shown in FIGS. 7C and 7D, the electronic device may display a plurality of contents included in the selected contents on the touch screen. Also, the electronic device may provide information about the selected contents. In more detail, the electronic device may reproduce the information about the selected contents as voices. Also, the electronic device may display the information about the selected contents.

For example, as shown in FIG. 7D, when it is determined that selected contents are an image photographed in an “A area”, the electronic device may provide information indicating that “there is an image photographed during travel of an A area” through the speaker. Also, the electronic device may display notification information indicating that “there is an image photographed during travel of an A area” on the touch screen.

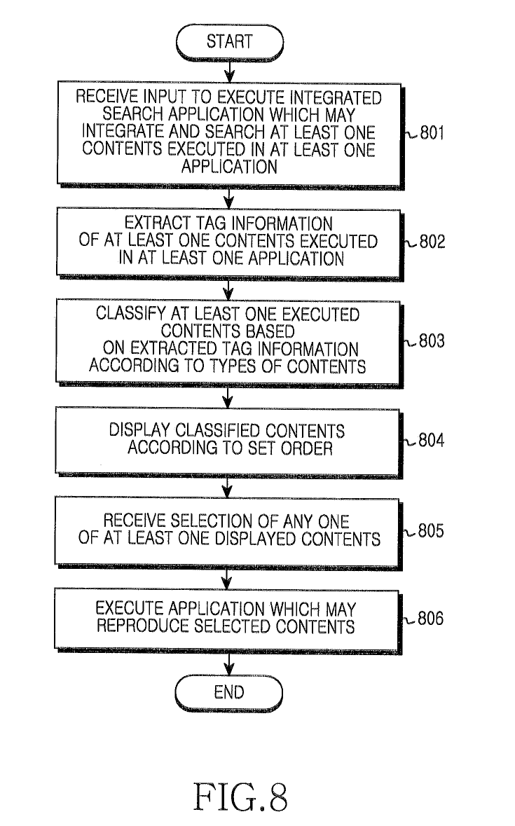

FIG. 8 is a flowchart illustrating an operation process of an electronic device according to one embodiment of the present disclosure.

As shown in FIG. 8, the electronic device may receive input to execute an integrated search application which may integrate and search at least one contents executed in at least one application (step 801). Herein, the integrated search application may be an application which may integrate, search, and execute contents executed in different applications.

Thereafter, the electronic device may extract tag information of at least the one contents executed in at least the one application (step 802). For example, receiving user input for input to execute the integrated search application, the electronic device may extract tag information of contents executed in applications to classify contents executed therein according to types of the contents.

The electronic device may classify at least the one executed contents based on the extracted tag information according to types of the contents (step 803). For example, a description will be given when a sound source playback application, a video playback application, and an image viewer application are executed in the electronic device. As described above, the electronic device may classify at least the one executed contents into sound source contents, video contents, and image contents roughly based on the extracted tag information. Thereafter, the electronic device may distinctively classify the classified contents while being classified according to a time when each of the applications is generated, a place where each of the applications is generated, and the same face among faces included in contents to classify the classified contents again in detail.

Thereafter, the electronic device may display the classified contents according to a set order (step 804). In more detail, the electronic device may classify contents primarily in the order of a time when the contents are executed, verify display priority of each of the classified contents secondarily, and display the contents.

The electronic device may receive selection of any one of at least the one displayed contents (step 805). In more detail, the electronic device may receive user input for selecting any one of contents displayed according to a unit of a time when the contents are executed and display priority.

Thereafter, the electronic device may execute an application which may reproduce the selected contents (step 806). For example, when sound source contents are selected, the electronic device may execute the sound source playback application and reproduce the selected sound source playback contents.

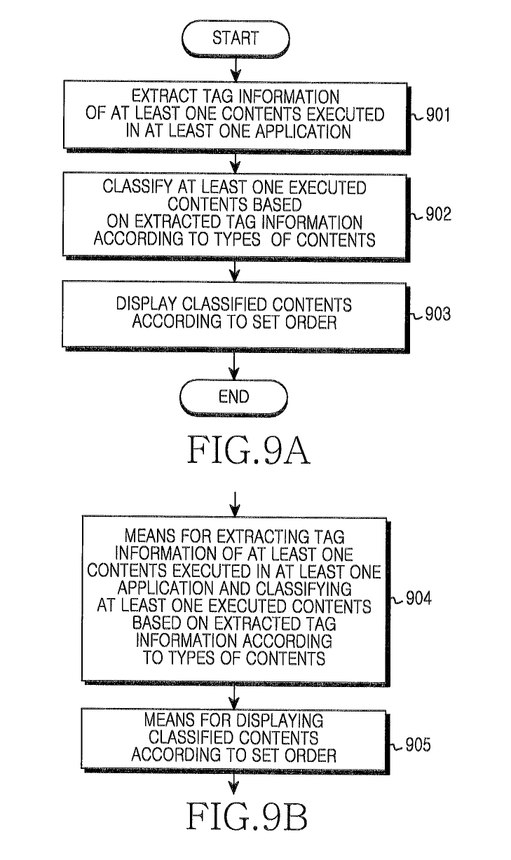

FIG. 9A is a flowchart illustrating a process of integrating and searching executed contents in an electronic device according to one embodiment of the present disclosure.

As shown in FIG. 9A, the electronic device may extract tag information of at least one contents executed in at least one application (step 901). For example, receiving user input for input to execute an integrated search application, the electronic device may extract tag information of contents executed in applications to classify contents executed therein according to types of the contents.

Thereafter, the electronic device may classify at least the one executed contents based on the extracted tag information according to types of the contents (step 902). For example, the electronic device may distinctively classify contents of the same type among the executed contents while being classified according to a time when each of the applications is generated, a place where each of the applications is generated, and the same face among faces included in contents.

The electronic device may display the classified contents according to a set order (step 903). In more detail, the electronic device may classify contents primarily in the order of a time when the contents are executed, verify display priority of each of the classified contents secondarily, and display the contents. Thereafter, receiving user input for selecting any one of the displayed contents, the electronic device may execute an application which may reproduce the selected contents.

FIG. 9B is a block diagram illustrating configuration of an electronic device for integrating and searching executed contents according to one embodiment of the present disclosure.

As shown in FIG. 9B, a means 904 of the electronic device, for example, a processor module may extract tag information of at least one contents executed in at least one application and classify at least the one executed contents based on the extracted tag information according to types of the contents. For example, receiving user input for input to execute an integrated search application, the processor module of the electronic device may extract tag information of contents executed in applications to classify contents executed in the electronic device according to types of the contents.

Thereafter, a means 905 of the electronic device, for example, a touch screen may display the classified contents according to a set order. In more detail, the processor module of the electronic device may classify contents primarily in the order of a time when the contents are executed. The touch screen of the electronic device may verify display priority of each of the classified contents secondarily and display the contents. Thereafter, receiving user input for selecting any one of the displayed contents, the electronic device may execute an application which may reproduce the selected contents.

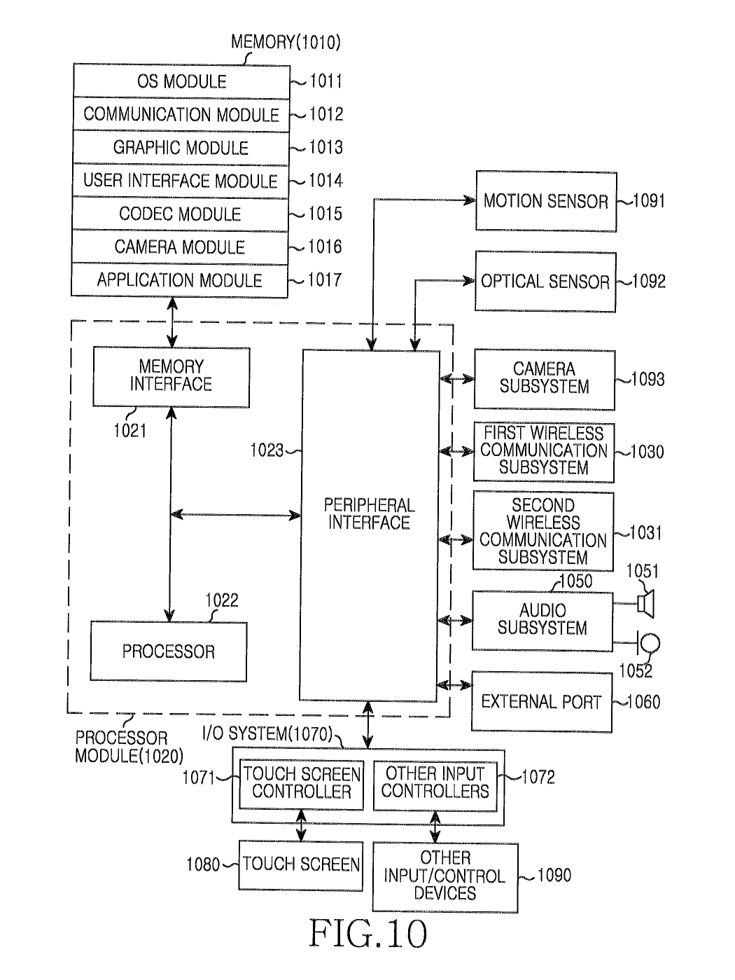

FIG. 10 is a block diagram illustrating configuration of an electronic device according to one embodiment of the present disclosure.

This electronic device denoted by 1000 may be a portable electronic device. The electronic device 1000 may be any one of apparatuses such as a portable terminal, a mobile phone, a mobile pad, a media player, a tablet computer, a handheld computer, and a Personal Digital Assistant (PDA). Also, the electronic device 1000 may be a certain portable electronic device including a device in which two or more functions are combined among these apparatuses.

This electronic device 1000 includes a memory 1010, a processor module 1020, a first wireless communication subsystem 1030, a second wireless communication subsystem 1031, an external port 1060, an audio subsystem 1050, a speaker 1051, a microphone 1052, an Input/Output (I/O) system 1070, a touch screen 1080, other input/control devices 1090, a motion sensor 1091, an optical sensor 1092, and a camera subsystem 1093. The memory 1010 and the external port 1060 may be a plurality of memories and external ports, respectively.

The processor module 1020 may include a memory interface 1021, one or more processors 1022, and a peripheral interface 1023. In some cases, the whole processor module 1020 is referred to as a processor. In accordance with one embodiment of the present disclosure, the processor module 1020 may extract tag information of at least one contents executed in at least one application and classify at least the one executed contents based on the extracted tag information according to types of the contents. Also, the processor module 1020 may distinctively classify contents of the same type among at least the one executed contents while being classified according to a time when the contents are generated, a place where the contents are generated, and the same face among faces included in the contents. Also, the processor module 1020 may verify a time when at least one contents are executed and verify an order set to display at least the one classified contents. Also, the processor module 1020 may execute an application which may reproduce selected contents.

The processor 1022 executes several software programs and performs several functions for the electronic device 1000. Also, the processor 1022 performs process and control for voice communication and data communication. Also, in addition to this normal function, the processor 1022 plays a role in executing a specific software module (instruction set) stored in the memory 1010 and performing several specific functions corresponding to the software module. That is, the processor 1022 interworks with the software modules stored in the memory 1010 and performs the method according to one embodiment of the present disclosure.

The processor 1022 may include one or more data processors, an image processor, or a codec. The processor 1022 may separately include the data processors, the image processor, or the codec. Also, the processor 1022 may include several processors for performing different functions. The peripheral interface 1023 connects the I/O system 1070 of the electronic device 1000 and several peripheral devices to the processor 1022 and the memory 1010 (though the memory interface 1021).

A variety of components of the electronic device 1000 may be coupled by one or more communication buses (not written in reference numbers) or stream lines (not written in reference numbers).

The external port 1060 is used to connect a portable electronic device (not shown) to another electronic device directly or connect the electronic device 1000 to another electronic device indirectly through a network (e.g., the Internet, an intranet, a wireless Local Area Network (LAN), etc.). For example, the external port 1060 means, which are not limited to, a Universal Serial Bus (USB) port, a firewire port, etc.

The motion sensor 1091 and the optical sensor 1092 may connect to the peripheral interface 1023 and perform several functions. For example, the motion sensor 1091 and the optical sensor 1092 may connect to the peripheral interface 1023, sense motion of the electronic device 1000, and sense light from the outside. Furthermore, a position measurement system and other sensors such as a temperature sensor, a bio-sensor, etc. may connect to the peripheral interface 1023 and perform related functions.

The camera subsystem 1093 may perform a camera function like a photo and video clip recording function.

The optical sensor 1092 may be a Charge Coupled Device (CCD) or a Complementary Metal-Oxide Semiconductor (CMOS) device.

A communication function is performed through the first and second wireless communication subsystems 1030 and 1031. Each of the first and second wireless communication subsystems 1030 and 1031 may include a radio frequency receiver and transceiver and/or a beam (e.g., infrared ray) receiver and transceiver. The first communication subsystem 1030 and the second communication subsystem 1031 may be classified according to a communication network through which the electronic device 1000 communicates. For example, the communication network may be, but is not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless Fidelity (Wi-Fi) network, a WiMax network, or/and a Bluetooth network. Each of the first and second communication subsystems 1030 and 1031 may include a communication subsystem designed to be operated through the communication network. The first and second wireless communication subsystems 1030 and 1031 may be combined and configured as one wireless communication subsystem.

The audio subsystem 1050 may connect to the speaker 1051 and the microphone 1052 and be responsible for inputting and outputting an audio stream, such as a voice recognition function, a voice copy function, a digital recording function, and a phone call function. That is, the audio subsystem 1050 communicates with a user through the speaker 1051 and the microphone 1052. The audio subsystem 1050 receives a data stream through the peripheral interface 1023 of the processor module 1020 and converts the received data stream into an electric stream. The converted electric stream is transmitted to the speaker 1051. The speaker 1051 converts the electric stream into a sound wave to which people may listen and outputs the converted sound wave. The microphone 1052 converts a sound wave transmitted from people or other sound sources into an electric stream. The audio subsystem 1050 receives the converted electric stream from the microphone 1052. The audio subsystem 1050 converts the received electric stream into an audio data stream and transmits the converted audio data stream to the peripheral interface 1023. The audio subsystem 1050 may include an attachable and detachable earphone, headphone, or headset.

The I/O system 1070 may include a touch screen controller 1071 and/or other input controllers 1072. The touch screen controller 1071 may be coupled to the touch screen 1080. The touch screen 1080 and the touch screen controller 1071 may detect, but is not limited to, contact and motion or stop of them using not only capacitive, resistive, infrared ray, and surface acoustic wave technologies for determining one or more contact points with the touch screen 1080 but also a certain multi-touch sensing technology including other proximity sensor arrangement or other elements. The other input controllers 1072 may be coupled to the other input/control devices 1090. The other input/control devices 1090 may be pointer devices such as one or more buttons, a rocket switch, a thumb-wheel, a dial, a stick, and/or a stylus.

The touch screen 1080 provides an input/output interface between the electronic device 1000 and the user. That is, the touch screen 1080 transmits touch input of the user to the electronic device 1000. Also, the touch screen 1080 is a medium for displaying output from the electronic device 1000 to the user. That is, the touch screen 1080 displays visual output to the user. This visual output has a text type, a graphic type, a video type, and a combined type of them.

The touch screen 1080 may be at least one of several displays. For example, the touch screen 1080 may be, but is not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). The touch screen 1080 according to one embodiment of the present disclosure may display classified contents according to a set order and receive input to execute an integrated search application which may integrate and search at least one contents executed in at least one application. Also, the touch screen 1080 may display at least one contents classified in a set order according to a unit of a time when at least one contents are executed and receive selection of any one of at least the one displayed contents. Also, the touch screen 1080 may display at least one contents of the same type as selected contents, receive selection of any one of at least the one contents of the same type as the selected contents, and provide information about the selected contents. Also, the touch screen 1080 may display the information about the selected contents.

The memory 1010 may be coupled to the memory interface 1021. The memory 1010 may include a high-speed Random Access Memory (RAM) such as one or more magnetic storages, a non-volatile memory, one or more optical storages, and/or a flash memory (e.g., a NAND flash memory or a NOR flash memory).

The memory 1010 stores software components. The software components include an Operating System (OS) module 1011, a communication module 1012, a graphic module 1013, a user interface module 1014, a CODEC module 1015, a camera module 1016, one or more application modules 1017, etc. Also, the modules which are the software components may be expressed in a set of instructions. Accordingly, the modules are expressed in an instruction set. Also, the modules are expressed in programs.

The OS module 1011 (e.g., embedded OS such as Windows, Linux, Darwin, RTXC, UNIX, OS X, or VxWorks) includes several software components for controlling a general system operation. For example, control of this general system operation means memory management and control, storage hardware (device) control and management, power control and management, etc. This OS module 1011 also performs a function for smoothly communicating between several hardware components (devices) and software components (modules). When there is difference of a set picture vector value or more and it is verified that a picture vector value is held within a set picture vector value range, the memory 1010 according to one embodiment of the present disclosure may register a sound source file portion corresponding to a time when a reference picture vector value is extracted as a highlight estimation interval.

The communication module 1012 may communicate with other electronic devices such as a computer, a server, and/or a portable terminal through the first and second wireless communication subsystems 1030 and 1031 or the external port 1060. When a second screen is an application which may request transmission of a call and an object of a text type includes only numbers, the communication module 1012 according to one embodiment of the present disclosure may request the transmission of the call to the numbers.

The graphic module 1013 includes several software components for providing and displaying graphics on the touch screen 1080. The term “graphics” means that texts, web pages, icons, digital images, videos, animations, etc. are included.

The user interface module 1014 includes several software components related to a user interface. The user interface module 1014 includes contents about whether a state of a user interface is changed to any state, whether a state of a user interface is changed in any condition, etc.

The CODEC module 1015 may include software components related to encoding and decoding of video files. The CODEC module 1015 may include a video stream module such as an MPEG module and/or an H204 module. Also, the CODEC module 1015 may include a code module for several audio files such as AAA files, AMR files, and WMA files. Also, the CODEC module 1015 includes an instruction set corresponding to one embodiment of the present disclosure.

The camera module 1016 includes cameral-related software components capable of performing camera-related processes and functions.

The application module 1017 includes a browser function, an email function, an instant message function, a word processing function, a keyboard emulation function, an address book function, a touch list function, a widget function, a Digital Right Management (DRM) function, a voice recognition function, a voice copy function, a position determining function, a location based service function, etc.

A variety of functions of the electronic device 800, which are described above or to be described later, may be executed by one or more streaming processing, hardware including an Application Specific Integrated Circuit (ASIC), software, and/or combination of them.

It will be appreciated that embodiments of the present disclosure according to the claims and description in the specification can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of operating an electronic device, the method comprising:
extracting tag information of contents associated with at least one application;
classifying at least the contents based on the extracted tag information according to types of the contents; and
displaying the classified contents according to a set order.

2. The method of claim 1, further comprising receiving an input to execute an integrated search application for integrating and searching at least the contents associated with at least the one application.

3. The method of claim 1, wherein the tag information includes at least one of a same face among faces included in at least the contents executed in at least the one application, a type of at least the contents, a time when at least the contents were generated, and a place where at least the contents were generated.

4. The method of claim 1, wherein classifying of the executed contents based on the extracted tag information according to the types of the contents comprises distinctively classifying contents of a same type among at least the contents while being classified according to a time when the contents were generated, a place where the contents were generated, and a same face among faces included in the contents.

5. The method of claim 1, wherein displaying the classified contents according to the set order comprises:
identifying a time when at least the contents are executed;
identifying an order set to display at least the classified contents; and
displaying at least the classified contents in the set order according to a unit of the time when at least the contents are executed.

6. The method of claim 5, wherein the unit of the time includes at least one of a day unit, a week unit, a month unit, and a year unit.

7. The method of claim 1, further comprising:
receiving selection of one of the displayed contents; and
executing an application for reproducing the selected contents.

8. The method of claim 7, further comprising:
displaying contents of a same type as the one selected contents;
receiving a selection of one of the contents of the same type as the one selected contents; and
providing information about the one selected contents of the same type.

9. The method of claim 8, wherein providing the information comprises reproducing the information as sound.

10. The method of claim 8, wherein providing the information comprises displaying the information.

11. An electronic device comprising:
a processor configured to extract tag information of contents associated with at least one application and classify at least the contents based on the extracted tag information according to types of the contents; and
a touch screen configured to display the classified contents according to a set order.

12. The electronic device of claim 11, wherein the touch screen is configured to receive an input to execute an integrated search application for integrating and searching at least the contents associated with at least the one application.

13. The electronic device of claim 11, wherein the tag information includes at least one of a same face among faces included in at least the contents executed in at least the one application, a type of at least the contents, a time when at least the contents were generated, and a place where at least the one contents were generated.

14. The electronic device of claim 11, wherein the processor is configured to distinctively classify contents of a same type among at least the contents while being classified according to a time when the contents were generated, a place where the contents were generated, and a same face among faces included in the contents.

15. The electronic device of claim 11, wherein:
the processor is configured to identify a time when at least the contents are executed and identify an order set to display at least the classified contents; and
the touch screen is configured to display at least the classified contents in the set order according to a unit of the time when at least the contents are executed.

16. The electronic device of claim 15, wherein the unit of the time includes at least one of a day unit, a week unit, a month unit, and a year unit.

17. The electronic device of claim 11, wherein:
the touch screen is configured to receive selection of one of the displayed contents; and
the processor is configured to execute an application for reproducing the selected contents.

18. The electronic device of claim 17, wherein the touch screen is configured to display contents of a same type as the one selected contents, receive a selection of one of the contents of the same type as the one selected contents, and provide information about the one selected contents of the same type.

19. The electronic device of claim 18, further comprising a speaker configured to reproduce the information as sound.

20. The electronic device of claim 18, wherein the touch screen is configured to display the information.
